(19) United States
(12) Patent Application Publication
(10) Pub. No.: US 2014/0182438 A1
(43) Pub. Date: Jul. 3, 2014

(54) CUTTING DEVICE

(71) Applicant: SHENZHEN CHINA STAR OPTOELECTRONICS TECHNOLOGY CO. LTD., Shenzhen, Guangdong (CN)

(72) Inventors: Feng She, Shenzhen (CN); Dong Li, Shenzhen (CN); Cheng-ming Huang, Shenzhen (CN)

(73) Assignee: SHENZHEN CHINA STAR OPTOELCTRONICS TECHNOLOGY CO., LTD., Shenzhen, Guangdong (CN)

(21) Appl. No.: 13/703,244

(22) PCT Filed: Aug. 10, 2012
(86) PCT No.: PCT/CN12/79911

§ 371 Date: Dec. 10, 2012

(30) Foreign Application Priority Data
Jul. 18, 2012 (CN) 201220348974.5

(51) Int. Cl. B26D 7/26; C03B 33/02

(52) U.S. Cl. CPC B26D 7/2614; C03B 33/02
USPC 83/483; 83/469

(57) ABSTRACT

A cutting device includes a housing, a bearing, a base, and a rotary cutter. The housing defines a receiving chamber. The bearing is received in the receiving chamber and includes an inner ring and an exterior ring contacting an interior wall of the housing. The base is secured to the inner ring of the base and has one end protruding out of the housing. The rotary cutter includes a head and a securing shaft, and the securing shaft has a first end secured to the head and a second end secured to the end of the base protruding out of the housing. The cutting device can prevent small glass pieces from dropping into the bearing and affecting the rotation of the bearing, thereby extending the service life of the bearing as well as guaranteeing smooth rotation of the bearing to improve the quality of the cutting operation.

### BACKGROUND

1. Technical Field

The present disclosure relates to cutting technologies, and particularly, to a cutting device for a liquid crystal panel.

2. Description of Related Art

A cutting device is a main manufacturing device for a liquid crystal panel. During the manufacturing process of the liquid crystal panel, the cutting device is used for cutting the liquid crystal panel to appropriate sizes according to requirements; or, the cutting device is used for cutting a color filter of the liquid crystal panel to reveal terminals of an array substrate to allow for the alignment of the liquid crystal panel.

A present cutting device for the liquid crystal panel generally includes a bearing, a rotary cutter connecting shaft, and a head. The bearing includes an inner securing ring. The rotary cutter connecting shaft is connected to the inner ring of the bearing. The head is secured to one end of the rotary cutter connecting shaft. When cutting the liquid crystal panel, the head cuts the liquid crystal panel and produces glass pieces. Since the bearing is exposed outside, the glass pieces may drop onto the bearing along the rotary cutter connecting shaft and pile up on the bearing, which blocks the rotation of the bearing, shortens the service life of the bearing and thus affects the quality of the cutting operation.

Therefore, when cutting the liquid crystal panel by the cutting device, how to prevent the glass pieces from dropping into the bearing has become the problem needs to be solved.

### SUMMARY

The present disclosure provides a cutting device. The cutting device includes a housing, a bearing, a base, and a rotary cutter. The housing defines a receiving chamber. The bearing s received in the receiving chamber and includes an inner ring and an exterior ring contacting an interior wall of the housing. The base is secured to the inner ring of the base and has one end protruding out of the housing. The rotary cutter includes a head and a securing shaft, and the securing shaft has a first end secured to the head and a second end secured to the end of the base protruding out of the housing.

Preferably, the end of the base secured to the rotary cutter is recessed to form a receiving portion, at least one protrusion is arranged on an interior wall of the receiving portion; at least one groove engageable with the at least one protrusion is defined in the second end to engage with the at least one protrusion.

Preferably, the end of the base secured to the rotary cutter forms a securing portion, a securing ring is arranged inside the securing portion; at least one protrusion is arranged on an interior wall of the securing ring; at least one groove engageable with the at least one protrusion is defined in the second end to engage with the at least one protrusion.

Preferably, the end of the base secured to the rotary cutter is recessed to form a receiving portion, an interior wall of the receiving portion is recessed to form at least one groove; at least one protrusion engageable with the at least one groove is arranged on the second end to engage with the at least one groove.

Preferably, the end of the base secured to the rotary cutter forms a securing portion, a securing ring is secured inside the securing portion, an interior wall of the securing ring is recessed to form at least one groove; and at least one protrusion is arranged on the second end to engage with the at least one groove.

Preferably, the cutting device further includes a motor and a leadscrew, and the leadscrew is connected to the motor and the housing.

Preferably, the housing includes two opposite supporting arms and a connecting arm for connecting two distal ends of the two supporting arms; the connecting arm includes a screw hole engageable with the leadscrew; the leadscrew includes external screw threads and the screw hole includes internal screw threads engageable with the external screw threads.

Preferably, the cutting device further includes a guiding rail, and the housing defines a guiding groove receiving the guiding rail therein.

The present disclosure further provides another cutting device. The cutting device includes a housing defining a receiving chamber, a base with one end protruding out of the housing, a bearing secured to the base and received in the receiving chamber, and a rotary cutter secured to the end of the base protruding out of the housing.

Preferably, the end of the base secured to the rotary cutter forms a receiving portion, and at least one protrusion is arranged on an interior wall of the receiving portion.

Preferably, the rotary cutter includes a head and a securing shaft, the securing shaft includes a first end and a second end, the first end is secured to the head, the second end is secured to the base and defines at least one groove engageable with the at least one protrusion, and the at least one protrusion engages with the at least one groove.

Preferably, the end of the base secured to the rotary cutter forms a securing portion, a securing ring is fixed inside the securing portion, and at least one protrusion is arranged on an interior wall of the securing ring.

Preferably, the rotary cutter includes a head and a securing shaft, the securing shaft includes a first end and a second end, the first end is secured to the head and the second end is secured to the base, the second end further defines at least one groove engageable with the at least one protrusion, and the at least one protrusion engages with the at least one groove.

Preferably, the end of the base secured to the rotary cutter forms a receiving portion, and at least one groove is defined on an interior wall of the receiving portion.

Preferably, the rotary cutter includes a head and a securing shaft, the securing shaft includes a first end and a second end, the first end is secured to the head, the second end is secured to the base and defines at least one groove engageable with the at least one protrusion, and the at least one protrusion engages with the at least one groove.

Preferably, the end of the base secured to the rotary cutter forms a securing portion, a securing ring is secured inside the securing portion, and an interior wall of the securing ring is recessed to define at least one groove.

Preferably, the rotary cutter includes a head and a securing shaft, the securing shaft includes a first end and a second end, the first end is secured to the head and the second end is secured to the base, and at least one protrusion engageable with the at least one groove is arranged on the second end to engage with the at least one groove.

Preferably, the cutting device further includes a motor and a leadscrew, and the leadscrew is connected to the motor and the housing.

Preferably, the housing includes two opposite supporting arms and a connecting arm for connecting two distal ends of the two supporting arms; the connecting arm includes a screw hole engageable with the leadscrew; the leadscrew includes external screw threads and the screw hole includes internal screw threads engageable with the external screw threads.

Preferably, the cutting device further includes a guiding rail, and the housing defines a guiding groove receiving the guiding rail therein.

With the bearing arranged inside the housing, small glass pieces produced during the cutting process of the liquid crystal panel are allowed to drop onto the housing along the rotary cutter. Thus, the cutting device of the present disclosure is capable of preventing small glass pieces from dropping into the bearing to influence the rotation of the bearing, thereby extending the service life of the bearing, guaranteeing the smooth rotation of the bearing as well as improving the quality of the cutting operation.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a cutting device in accordance with an embodiment of the present disclosure;

FIG. 2 is a partial cross-section view of the cutting device of FIG. 1;

FIG. 3 is a bottom view of a securing ring of the cutting device in accordance with a first embodiment of the present disclosure;

FIG. 4 is a bottom view of a securing ring of the cutting device in accordance with a second embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

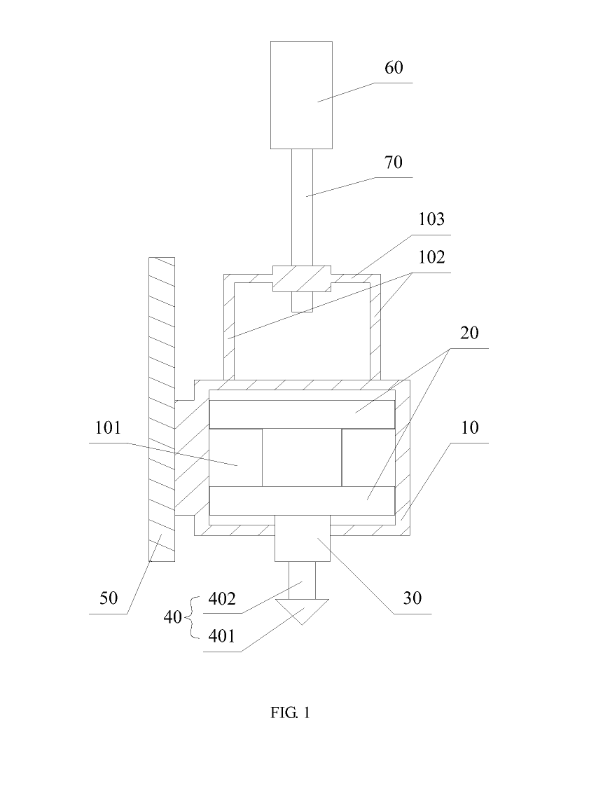

Referring to FIG. 1, which is a schematic view of a cutting device in accordance with an embodiment of the present disclosure. The cutting device includes a house 10, bearings 20, a base 30, and a rotary cutter 40. The house 10 defines a receiving chamber 101 for receiving the bearings 20. The bearings 20 are configured on the base 30 and received in the receiving chamber 101 of the housing 10. The base 30 includes an end protruding out of the house 10 on which the rotary cutter 40 is arranged.

The bearing 20 includes an inner ring 21, an exterior ring 22 and balls 23 arranged between the inner ring 21 and the exterior ring 22. The inner ring 21 is secured to the base 30 and the exterior ring 22 is attached to an interior wall of the housing 10. The base 30 is partly received in the receiving chamber 101 for securing the bearing 20. The rotary cutter 40 is secured on the end of the base 30 protruding out of the housing 10. In some embodiments, the rotary cutter 40 can be attractedly secured to the base 30 by using the electromagnetic principle. It is noted that the number of the bearings 20 is not limited to this embodiment and can be changed according to different requirements. In the embodiment, the number of the bearing 20 is preferably two and the two bearings 20 are arranged on the base 30 side by side.

In the present disclosure, the bearing 20 is arranged inside the housing 10, therefore, small glass pieces are allowed drop onto the housing 10 when the cutting device is cutting a liquid crystal panel. In this way, the cutting device of the present disclosure can prevent small glass pieces from dropping into the bearing 20 and further from affecting the rotation of the bearing 20. This extends the service life of the bearing 20, guarantees the smooth rotation of the bearing 20, and improves the quality of the cutting operation.

It is noted that the base 30 can be pillar shaped. In the embodiment, the base 30 is preferably cylindrical. The base 30 partly protrudes out of the housing 10. For example, the housing 10 may define an opening engageable with the base 30 such that the base 30 can protrude out of the housing 10 through there through. The bearing 20 is received in the receiving chamber 101 of the housing 10 and is secured to the base 30. The base 30 passes through the opening of the housing 10 to be secured to the rotary cutter 40. Since the opening is engageable with the base 30, the small glass pieces are prevented from dropping into the bearing 20 to influence the rotation of the bearing 20.

Furthermore, the rotary cutter 40 includes a head 401 and a securing shaft 402. The securing shaft 402 includes a first end and a second end. The first end is secured to the head 401 and the second end is secured to the base 30.

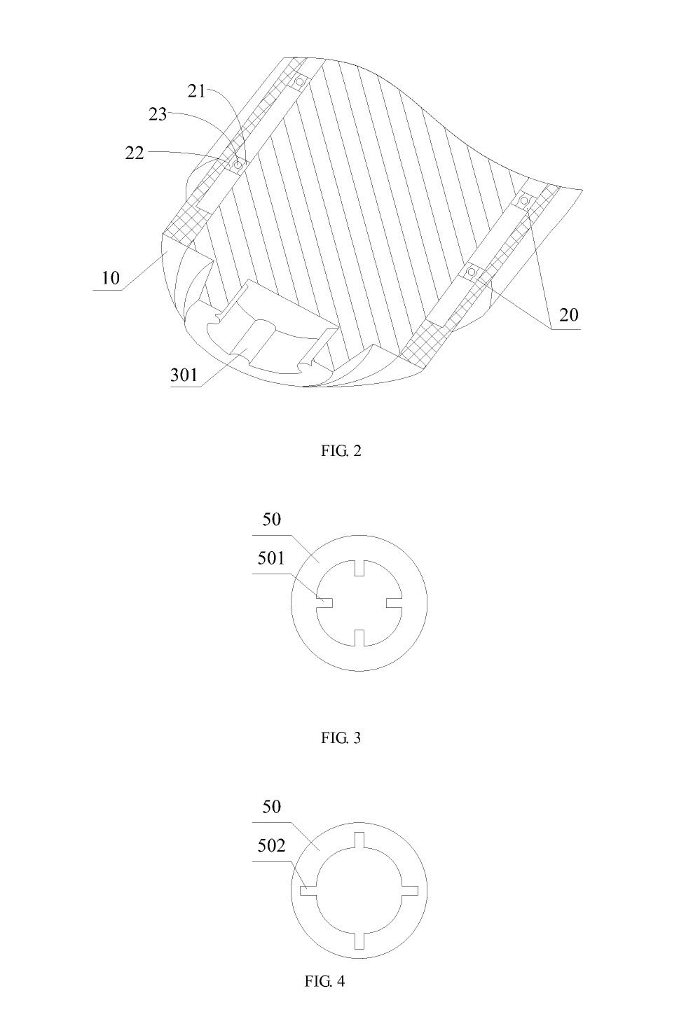

Referring also to FIG. 2, which is a partial cross-section view of the cutting device. In the embodiment, the second end of the securing shaft 402 is meshed with base 30.

Specifically, one end of the base 30 which is connected to the securing shaft 402 is recessed to form a receiving portion for arranging the securing shaft 402. At least one protrusion 301 is arranged on an interior wall of the receiving portion, which is capable of engaging with at least one groove defined in the securing shaft 402. The protrusion 301 engages with the groove of the securing shaft 402 to prevent the securing shaft 402 from rotating inside the base 30, thus, the connection between the base 30 and the securing shaft 402 is reinforced.

It is noted that the configuration of the protrusion 301 is not limited to the embodiment. In other embodiments, the number and the location of the protrusion 301 can be modified according to different requirements. Preferably, the number of the protrusion 301 is four and the four protrusions 301 are equidistantly arranged on the interior wall of the receiving portion.

In other embodiments, the groove may be defined in the interior wall of the receiving portion of the base 30, and the protrusion may be arranged on the securing shaft 402. The groove is engageable with the protrusion of the securing shaft 402 to prevent the securing shaft 402 from rotating inside the base 30, which reinforces the connection between the base 30 and the securing shaft 402.

It is noted that the configuration of the groove is not limited to this embodiment. In other embodiments, the number and the location of the groove can be modified according to different requirements.

In the above embodiments, the protrusion 301 of the base 30 can be integrally formed with the base 30. In other embodiments, the end of the base 30 which is secured to the rotary cutter 40 can form a securing portion. The securing portion can include a securing ring engaging with the rotary cutter 40.

Referring to FIG. 3, which is a bottom view of the securing ring of a first embodiment. The securing ring 50 includes at least one protrusion 501 arranged on interior wall thereof. Correspondingly, the securing shaft 402 defines at least one groove engaging with the protrusion 501. The securing ring 50 is secured in the securing portion of the base 30, an exterior wall of the securing ring 50 contacts the interior wall of the securing portion and the protrusion 501 engages with the groove of the securing shaft 402.

Referring to FIG. 4, which is a bottom view of the securing ring of a second embodiment. An interior wall of the securing ring 50 is recessed to define at least one groove 502 and the securing shaft 402 correspondingly is provided with at least one protrusion engaging with the groove 502. The securing ring 50 is secured in the securing portion of the base 30, the exterior wall of the securing ring 50 contacts the interior wall of the securing portion and the groove 502 engages with the protrusion of the securing shaft 402.

In the above embodiments, the securing ring 50 and the base 30 are independent from each other and are assembled together. Thus, when the protrusion 501 or the groove 502 is damaged and cannot properly engage with rotary cutter 40, the securing ring 50 can be replaced without replacing the base 30, which simplifies the operation and reduces the cost.

Referring to FIG. 1 again, the cutting device further includes a guiding rail 50, a motor 60, and a leadscrew 70. The leadscrew 70 is rotatably connected to the motor 60 and a connecting arm 103. The housing 10 defines a guiding groove engaging with the guiding rail 50.

In the embodiment, the housing 10 includes two opposite supporting arms 102 and the connecting arm 103 for connecting two distal ends of the two supporting arms 102. The connecting arm 103 defines a screw hole to engage with the leadscrew 70. The leadscrew 70 includes external screw threads. The screw hole is provided with internal screw threads engageable with the external screw threads of the leadscrew 70. The guiding rail 50 is located in the guiding groove of the housing 10 so that the housing 10 can slide along the guiding rail 50. In use, the motor 60 drives the leadscrew 70 to rotate to allow the screw hole to move upwards and downwards along the leadscrew 70. Thus, the housing 10 is capable of sliding along the guiding rail 50, which further drives the bearing 20, the base 30, and the head 40 to move upwards and downwards.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A cutting device, comprising:
a housing defining a receiving chamber;
bearings received in the receiving chamber, the bearing comprising an inner ring and an exterior ring contacting an interior wall of the housing;
a base secured to the inner ring of the base and having one end protruding out of the housing; and
a rotary cutter comprising a head and a securing shaft, the securing shaft having a first end secured to the head and a second end secured to the end of the base protruding out of the housing.

2. The cutting device as claimed in claim 1, wherein the end of the base secured to the rotary cutter is recessed to form a receiving portion, at least one protrusion is arranged on an interior wall of the receiving portion; at least one groove engageable with the at least one protrusion is defined in the second end to engage with the at least one protrusion.

3. The cutting device as claimed in claim 1, wherein the end of the base secured to the rotary cutter forms a securing portion, a securing ring is arranged inside the securing portion; at least one protrusion is arranged on an interior wall of the securing ring; at least one groove engageable with the at least one protrusion is defined in the second end to engage with the at least one protrusion.

4. The cutting device as claimed in claim 1, wherein the end of the base secured to the rotary cutter is recessed to form a receiving portion, an interior wall of the receiving portion is recessed to form at least one groove; and at least one protrusion engageable with the at least one groove is arranged on the second end to engage with the at least one groove.

5. The cutting device as claimed in claim 1, wherein the end of the base secured to the rotary cutter forms a securing portion, a securing ring is arranged inside the securing portion, an interior wall of the securing ring is recessed to form at least one groove; at least one protrusion engageable with the at least one groove is arranged on the second end to engage with the at least one groove.

6. The cutting device as claimed in claim 1, wherein the cutting device further comprises a motor and a leadscrew, and the leadscrew is connected to the motor and the housing.

7. The cutting device as claimed in claim 6, wherein the housing comprises two opposite supporting arms and a connecting arm for connecting two distal ends of the two supporting arms; the connecting arm comprises a screw hole engageable with the leadscrew; the leadscrew comprises external screw threads and the screw hole comprises internal screw threads engageable with the external screw threads.

8. The cutting device as claimed in claim 6, wherein the cutting device further comprises a guiding rail, and the housing defines a guiding groove receiving the guiding rail therein.

9. A cutting device, comprising:
a housing defining a receiving chamber;
a base with one end protruding out of the housing;
a bearing secured to the base and received in the receiving chamber; and
a rotary cutter secured to the end of the base protruding out of the housing.

10. The cutting device as claimed in claim 9, wherein the end of the base secured to the rotary cutter forms a receiving portion, and at least one protrusion is arranged on an interior wall of the receiving portion.

11. The cutting device as claimed in claim 10, wherein the rotary cutter comprises a head and a securing shaft, the securing shaft comprises a first end and a second end, the first end is secured to the head, the second end is secured to the base and defines at least one groove engageable with the at least one protrusion, and the at least one protrusion engages with the at least one groove.

12. The cutting device as claimed in claim 9, wherein the end of the base secured to the rotary cutter forms a securing portion, a securing ring is fixed inside the securing portion, and at least one protrusion is arranged on an interior wall of the securing ring.

13. The cutting device as claimed in claim 12, wherein the rotary cutter comprises a head and a securing shaft, the securing shaft comprises a first end and a second end, the first end is secured to the head and the second end is secured to the base, the second end further defines at least one groove engageable with the at least one protrusion, and the at least one protrusion engages with the at least one groove.

14. The cutting device as claimed in claim 9, wherein the end of the base secured to the rotary cutter forms a receiving portion, and at least one groove is defined on an interior wall of the receiving portion.

15. The cutting device as claimed in claim 14, wherein the rotary cutter comprises a head and a securing shaft, the securing shaft comprises a first end and a second end, the first end is secured to the head, the second end is secured to the base and defines at least one groove engageable with the at least one protrusion, and the at least one protrusion engages with the at least one groove.

16. The cutting device as claimed in claim 9, wherein the end of the base secured to the rotary cutter forms a securing portion, a securing ring is secured inside the securing portion, and an interior wall of the securing ring is recessed to define at least one groove.

17. The cutting device as claimed in claim 16, wherein the rotary cutter comprises a head and a securing shaft, the securing shaft comprises a first end and a second end, the first end is secured to the head and the second end is secured to the base, and at least one protrusion engageable with the at least one groove is arranged on the second end to engage with the at least one groove.

18. The cutting device as claimed in claim 9, wherein the cutting device further comprises a motor and a leadscrew, and the leadscrew is connected to the motor and the housing.

19. The cutting device as claimed in claim 18, wherein the housing comprises two opposite supporting arms and a connecting arm for connecting two distal ends of the two supporting arms; the connecting arm comprises a screw hole engageable with the leadscrew; the leadscrew comprises external screw threads and the screw hole comprises internal screw threads engageable with the external screw threads.

20. The cutting device as claimed in claim 18, wherein the cutting device further comprises a guiding rail, and the housing defines a guiding groove receiving the guiding rail therein.
